(19) United States
(12) Patent Application Publication
(10) Pub. No.: US 2023/0097499 A1
(43) Pub. Date: Mar. 30, 2023

(54) POWER TRANSACTION MANAGEMENT SERVER AND POWER TRANSACTION PROCESSING DEVICE FOR MOBILE OBJECT

(71) Applicant: TOYOTA JIDOSHA KABUSHIKI KAISHA, Toyota-shi (JP)

(72) Inventors: Kazutaka KIMURA, Mishima-shi (JP); Kazuki OBATA, Susono-shi (JP); Satoshi KIKUCHI, Hadano-shi (JP); Yuki KUDO, Susono-shi (JP); Hiromitsu KIGURE, Kanagawa-ken (JP); Yuta MANIWA, Susono-shi (JP)

(21) Appl. No.: 17/813,414

(22) Filed: Jul. 19, 2022

(30) Foreign Application Priority Data
Sep. 24, 2021 (JP) 2021-155900

(51) Int. Cl. B60L 53/66; B60L 53/63; B60L 53/62

(52) U.S. Cl. CPC B60L 53/66; B60L 53/63; B60L 53/62

(57) ABSTRACT

In a power transaction management server, a registration unit receives power transaction information including positional information of a corresponding charging/discharging facility and tender conditions for a transaction of electric power and registers the received power transaction information in a storage device for each individual transaction market. An input unit receives information of a mobile object participating in a power transaction market. The information of the mobile object includes information indicating a geographical range in which the mobile object is able to supply or receive electric power. A setting unit sets retrieval conditions based on the information of the mobile object. A retrieval unit retrieves an individual transaction market matching the retrieval conditions out of a plurality of individual transaction markets. A provision unit provides the power transaction information in the individual transaction market matching the retrieval conditions.

### CROSS-REFERENCE TO RELATED APPLICATION

This application claims priority to Japanese Patent Application No. 2021-155900 filed on Sep. 24, 2021, incorporated herein by reference in its entirety.

### BACKGROUND

### 1. Technical Field

The present disclosure relates to a power transaction management server and a power transaction processing device for a mobile object.

### 2. Description of Related Art

Japanese Unexamined Patent Application Publication No. 2020-186951 (JP 2020-186951 A) discloses an information providing device including a retrieval unit configured to retrieve whether a charging facility capable of charging a motor-driven vehicle is present in a destination of the motor-driven vehicle set based on an input operation performed by a user of the motor-driven vehicle and a provision unit configured to change a route on which the motor-driven vehicle moves to the destination depending on whether a charging facility is present and to provide the route to the user of the motor-driven vehicle.

### SUMMARY

With liberalization of electric power, introduction of a peer-to-peer (P2P) power transaction in which electric power is directly transacted between an individual or a corporate body having power resources as well as a power company and a power consumer which is another individual or corporate body has been reviewed. In such a P2P power transaction, an individual or a corporate body can perform a transaction of electric power using a mobile object such as a motor-driven vehicle with a large-capacity storage battery by employing the mobile object as a power storage means.

When a P2P power transaction using a mobile object is performed, a “regular transaction market” and an “individual transaction market” are considered as a type of market. The “regular transaction market” is a market in which a contract for electric power that is supplied from a seller of electric power to a purchaser via a power transmission line of a system power network is made. The “individual transaction market” is a market in which a contract for electric power that is directly supplied or received by one party of a power transaction by causing a mobile object to move to the other party of the power transaction is made. When a mobile object can be supplied with electric power with which a storage battery is charged via an individual transaction market, it is very useful for reducing power costs. For example, as described in JP 2020-186951 A, since a mobile object can be supplied with electric power in the course of moving to a destination by providing information of a charging facility which is a transit point in moving to the destination to an owner of the mobile object, it is possible to reduce costs and labor for supply of electric power to a mobile object.

However, in JP 2020-186951 A, positional information of charging facilities is merely provided to an owner of a mobile object, but information on power transactions is not provided to the owner. Accordingly, in order to realize supply of electric power via an individual transaction market, there is demand for constructing a system that can acquire information of an individual transaction market which is advantageous for an owner of a mobile object.

The present disclosure provides a configuration for providing information on power transactions tendered in an individual transaction market to a mobile object such that the mobile object can participate in a power transaction with advantageous conditions in a P2P power transaction.

A power transaction management server according to an aspect of the present disclosure manages transactions of electric power in a power transaction market. The power transaction market includes a plurality of individual transaction markets that is provided to correspond to a plurality of charging/discharging facilities. Each of the plurality of individual transaction markets is configured to make a contract for a transaction of electric power directly supplied and received between the corresponding charging/discharging facility and a mobile object. The power transaction management server includes a storage device, a registration unit, an input unit, a setting unit, a retrieval unit, and a provision unit. The registration unit is configured to receive power transaction information including positional information of the corresponding charging/discharging facility and tender conditions for a transaction of electric power and to register the received power transaction information in the storage device for each individual transaction market. The input unit is configured to receive information of the mobile object participating in the power transaction market, the information of the mobile object including information indicating a geographical range in which the mobile object is able to supply or receive electric power. The setting unit is configured to set retrieval conditions based on the information of the mobile object. The retrieval unit is configured to retrieve an individual transaction market matching the retrieval conditions out of the plurality of individual transaction markets. The provision unit is configured to provide the power transaction information in the individual transaction market matching the retrieval conditions.

With this configuration, since the power transaction management server provides power transaction information in an individual transaction market for charging/discharging facilities located in a geographical range in which the mobile object is able to supply or receive electric power, a power transaction processing device for a mobile object (hereinafter also referred to as a “mobile object agent”) that makes a tender and a contract for the mobile object can efficiently collect the power transaction information of the individual transaction market serving as a tender destination of the mobile object. Since the mobile object agent can determine tender conditions in a transaction of electric power of the mobile object with reference to the provided power transaction information in the individual transaction market, the mobile object can participate in a transaction of electric power with advantageous conditions.

The tender conditions may include a time period in which the corresponding charging/discharging facility is able to supply and receive electric power and a market price per unit time period in the time period. The tender conditions may further include an amount of electric power per unit time period in the time period.

With this configuration, the mobile object agent can determine the tender conditions for a transaction of electric power in the mobile object based on the provided tender conditions. Accordingly, the mobile object can participate in a transaction of electric power with advantageous conditions.

The information of the mobile object may include information indicating a current location of the mobile object. The setting unit may be configured to set a geographical range determined based on the current location of the mobile object as the retrieval conditions.

With this configuration, since power transaction information of charging/discharging facilities located in a predetermined range from the current location of the mobile object is provided, the mobile object agent can determine the tender conditions using the provided power transaction information such that a profit in a transaction of electric power within a range of an amount of electric power according to which the storage battery of the mobile object is chargeable or dischargeable is maximized with reference to a future state of use of the mobile object.

The information of the mobile object may include information indicating an area that is a living zone of an owner of the mobile object. The setting unit may be configured to set a geographical range including the area corresponding to the living zone as the retrieval conditions.

With this configuration, since power transaction information of charging/discharging facilities located in a living zone of the owner of the mobile object is provided, the mobile object agent can determine the tender conditions using the provided power transaction information such that a profit in a transaction of electric power within a range of an amount of electric power according to which the storage battery of the mobile object is chargeable or dischargeable is maximized with reference to a future state of use of the mobile object.

The information of the mobile object may include information indicating a travel route from a current location of the mobile object to a destination. The setting unit may be configured to set a geographical range determined to include the travel route as the retrieval conditions.

With this configuration, since power transaction information of charging/discharging facilities located near the travel route to a destination is provided, the mobile object agent can determine the tender conditions using the provided power transaction information such that a profit in a transaction of electric power is maximized without greatly changing the travel route to a destination and an arrival time at the destination even when it is predicted that charging of the storage battery has to be performed before the mobile object arrives at the destination.

The power transaction information may further include information on a parking fee of the mobile object that is caused when electric power is supplied and received between the corresponding charging/discharging facility and the mobile object.

With this configuration, since the mobile object agent can accurately predict costs in a transaction of electric power, it is possible to determine tender conditions which are advantageous for the mobile object.

The power transaction information may further include information on an incentive that is applied to the mobile object with supply and reception of electric power between the corresponding charging/discharging facility and the mobile object.

With this configuration, since the mobile object agent can accurately predict a profit obtained in a transaction of electric power, it is possible to determine tender conditions which are advantageous for the mobile object.

The power transaction management server may further include a determination unit. The determination unit may be configured to acquire information on a market price per unit time period in the individual transaction market and to determine whether the acquired information on a market price per unit time period matches the information on a market price per unit time period stored in the storage device.

With this configuration, since a mismatch between the market price in an individual transaction market and the market price stored in the power transaction management server can be detected, it is possible to prevent disadvantages from being given to the mobile object making a tender in the individual transaction market due to the mismatch in market price.

The power transaction management server may further include a correction unit. The correction unit may be configured to acquire information on a market price per unit time period in the individual transaction market and to correct the information on a market price per unit time period stored in the storage device to match the acquired information on a market price per unit time period.

With this configuration, since a mismatch between the market price in an individual transaction market and the market price stored in the power transaction management server can be removed, it is possible to prevent disadvantages from being given to the mobile object making a tender in the individual transaction market due to the mismatch in market price.

A power transaction processing device for a mobile object according to another aspect of the present disclosure includes a communication circuit. The communication circuit is configured to transmit the information on a mobile object participating in the power transaction market to the power transaction management server according to the aspect. The communication circuit is configured to receive the power transaction information in the individual transaction market matching the retrieval conditions from the power transaction management server.

With this configuration, the power transaction processing device for a mobile object (a mobile object agent) can efficiently collect the power transaction information of the individual transaction markets for charging/discharging facilities located in a geographical range in which the mobile object is able to supply or receive electric power. Since the mobile object agent can determine tender conditions in a transaction of electric power of the mobile object with reference to the provided power transaction information in the individual transaction markets, the mobile object can participate in a transaction of electric power with advantageous conditions.

The power transaction processing device for a mobile object may further include a notification unit configured to notify an owner of the mobile object of the power transaction information received by the communication circuit via a user interface.

With this configuration, an owner of the mobile object can ascertain the power transaction information in an individual transaction market serving as a tender destination of the mobile object. When a plurality of individual transaction markets serving as a tender destination is provided, the owner of the mobile object can compare the power transaction information between the plurality of individual transaction markets.

The power transaction processing device for a mobile object may further include a determination unit. The determination unit may be configured to determine tender conditions for a transaction of electric power of the mobile object based on the power transaction information in the individual transaction market matching the retrieval conditions and a predicted state of use of the mobile object.

With this configuration, the mobile object agent can determine the tender conditions using the provided power transaction information such that a profit in a transaction of electric power is maximized with reference to a future state of use of the mobile object.

The determination unit may be configured to calculate an amount of electric power according to which a storage battery of the mobile object is chargeable or dischargeable per unit time period and a total amount of electric power which the mobile object is able to supply or receive to or from the corresponding charging/discharging facility based on the predicted state of use of the mobile object. The determination unit may be configured to determine a tendered power upper limit per unit time period in the mobile object based on the calculated amount of electric power according to which the storage battery of the mobile object is chargeable or dischargeable per unit time period, the calculated total amount of electric power which the mobile object is able to supply or receive to or from the corresponding charging/discharging facility, and an amount of electric power for each unit time period in the individual transaction market matching the retrieval conditions. The determination unit may be configured to determine the individual transaction market serving as a tender destination, an amount of electric power which the mobile object supplies or receives to or from the corresponding charging/discharging facility, and a market price for the electric power per unit time period based on the determined tendered power upper limit and the market price per unit time period in the individual transaction market matching the retrieval conditions.

With this configuration, the mobile object agent can determine the tender conditions using the provided power transaction information such that a profit in a transaction of electric power within a range of an amount of electric power according to which the storage battery of the mobile object is chargeable or dischargeable is maximized with reference to a future state of use of the mobile object.

The determination unit may be configured to notify an owner of the mobile object of the determined tender conditions for the mobile object via a user interface. The determination unit may be configured to make a contract when the tender conditions have been approved by the owner of the mobile object.

With this configuration, since a tender and a contract of the mobile object are made with the tender conditions which have been approved by the owner of the mobile object, it is possible to perform a transaction of electric power corresponding to an intention of the owner of the mobile object.

According to the present disclosure, it is possible to provide information on power transactions tendered in individual transaction markets to a mobile object such that the mobile object can participate in a power transaction with advantageous conditions in a P2P power transaction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a P2P power transaction system;

FIG. 2 is a diagram schematically illustrating the entire configuration of a power transaction information providing system according to a first embodiment;

FIG. 3 is a diagram illustrating a flow of processes which are performed in the power transaction information providing system;

FIG. 4 is a diagram illustrating an example of a structure of power transaction information;

FIG. 5 is a diagram illustrating a first example of a retrieval result that is displayed on a user interface;

FIG. 6 is a diagram illustrating a second example of a retrieval result that is displayed on the user interface;

FIG. 7 is a block diagram illustrating a functional configuration of a management server;

FIG. 8 is a block diagram illustrating a functional configuration of a mobile object agent;

FIG. 9 is a block diagram illustrating a functional configuration of a management server according to a second embodiment;

FIG. 10 is a block diagram illustrating a functional configuration of a management server according to a third embodiment; and

FIG. 11 is a block diagram illustrating a functional configuration of a management server according to a fourth embodiment.

### DETAILED DESCRIPTION OF EMBODIMENTS

Hereinafter, embodiments of the present disclosure will be described in detail with reference to the accompanying drawings. The same or corresponding elements in the drawings will be referred to by the same reference signs, and description thereof will not be repeated.

### First Embodiment

### Example of Configuration of P2P Power Transaction System

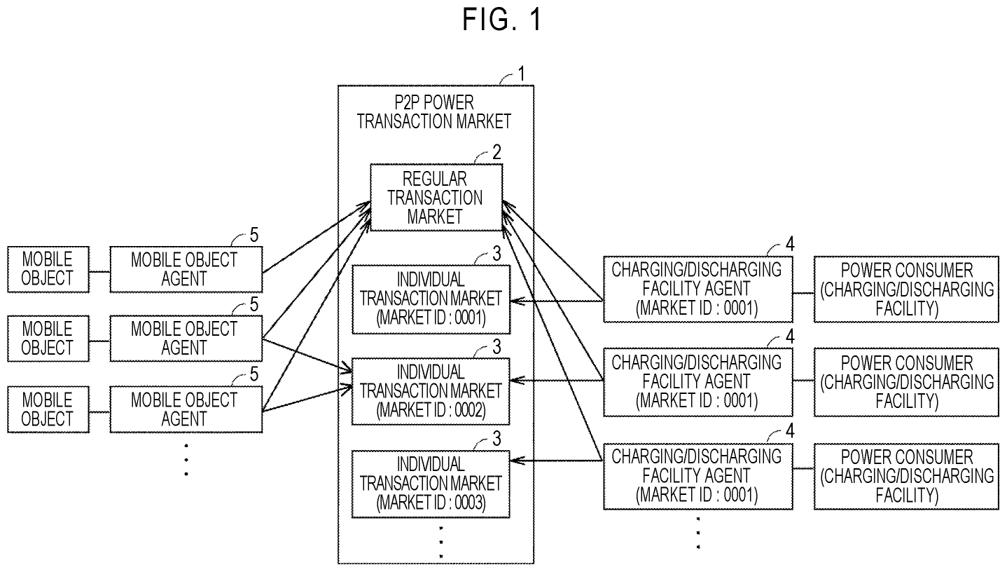

FIG. 1 is a diagram schematically illustrating an example of a configuration of a peer-to-peer (P2P) power transaction system to which a power transaction information providing system according to a first embodiment is applied.

As illustrated in FIG. 1, the P2P power transaction system includes charging/discharging facility agents 4 and mobile object agents 5. The charging/discharging facility agents 4 manage tenders and contracts for charging/discharging facilities owned by power consumers. The charging/discharging facility agents 4 include business agents that manage tenders and contracts of power consumers with a large amount of power consumption such as factories, commercial facilities, railway stations, and airports and house agents that manage tenders and contracts of power consumers with a normal amount of power consumption such as houses or small or medium stores. Each charging/discharging facility agent 4 corresponds to an example of a “power transaction processing device for a charging/discharging facility.”

Each mobile object agent 5 manages a tender and a contract of a mobile object such as a motor-driven vehicle. A storage battery that can be charged from the outside and that can discharge electric power to the outside is mounted in the mobile object. Examples of the mobile object include an electric vehicle, a hybrid vehicle, a plug-in hybrid vehicle, or an automated-driving vehicle that can transport luggage without a diver. A power consumer and a mobile object make a tender using an agent in charge. The mobile object agent 5 corresponds to an example of a “power transaction processing device for a mobile object.”

Each charging/discharging facility agent 4 and each mobile object agent 5 can transmit and receive information to and from an information processing device (a server) constituting the P2P power transaction market 1 via a communication network.

When a P2P transaction of electric power is performed using a mobile object, a “regular transaction market” and an “individual transaction market” are considered as forms of a market. The “regular transaction market” is a market in which a contract for electric power that is supplied from a seller of electric power to a purchaser via a power transmission line of a system power network (a power network for supplying electric power from a large-scale power plant operated by a power company) is made. The “individual transaction market” is a market in which a contract for electric power that is directly supplied or received by one party of a transaction of electric power by causing a mobile object to move to a location of the other party is made. For example, when a mobile object is a seller of electric power, the individual transaction market makes a contract for electric power that is supplied by causing the mobile object to move to a location of a purchaser of electric power.

As illustrated in FIG. 1, each charging/discharging facility agent 4 forms an individual transaction market 3 for making a contract for electric power which a charging/discharging facility directly supplies or receives to or from a mobile object for the charging/discharging facility to be managed. That is, in the P2P power transaction market 1, one individual transaction market 3 is formed for a power consumer having a charging/discharging facility. The individual transaction market 3 can be formed by a server that is managed by the power consumer. Alternatively, a plurality of individual transaction markets 3 may be formed together by one server.

In each individual transaction market 3, a power consumer makes a tender for sale or purchase for each unit time period via the charging/discharging facility agent 4, and a plurality of mobile objects makes a tender for sale or purchase for each unit time period using the mobile object agent 5.

In this specification, a “unit time period” denotes one time period out of a plurality of time periods obtained by dividing a time in which a transaction of electric power is performed by a predetermined time length set in the P2P power transaction market 1. Currently, since 24 hours is divided into 48 sections in Japan, the length of one unit time period is 30 minutes. A transaction for electric power is performed for an amount of electric power (power×length of unit time period) which is transmitted in the unit time period.

Each seller and each purchaser tender a pair of an amount of electric power and a price for each unit time period. A contract is made for a pair in which tender conditions of the seller and tender conditions of the purchaser match. In each individual transaction market 3, in general, a power consumer can make a tender for sale, and a mobile object and make a tender for purchase. In a case in which a power consumer performs peak cut which will be described later, the power consumer can make a tender for purchase and a mobile object can make a tender for sale.

The charging/discharging facility agent 4 issues identification information for identifying an individual transaction market 3 (hereinafter also referred to as an “market ID”) and a password for log-in to the individual transaction market and assigns the issued identification information and password to the individual transaction market 3. Accordingly, only a mobile object agent 5 having received the market ID and the password can make a tender in the individual transaction market 3. The number of individual transaction markets which can be selected as a tender destination of a mobile object agent may be one or more.

It is very useful for reducing power costs that a mobile object can be supplied with electric power with which the storage battery is charged from the individual transaction market 3. For example, when the storage battery can be charged using a charging/discharging facility located in a living zone of an owner of a mobile object, it is possible to reduce costs and labor for causing the mobile object to move to the charging/discharging facility. Alternatively, when the storage battery can be charged using a charging/discharging facility located on a travel route of the mobile object from a current location to a destination, it is advantageous in view of costs and labor.

For example, when an owner of a mobile object can charge the storage battery using a charging/discharging facility installed in a commercial facility during shopping in the commercial facility, it is also possible to improve convenience for the owner of the mobile object. In order to realize supply of electric power using such an individual transaction market 3, there is demand for constructing a system that can acquire information of individual transaction markets which is advantageous for mobile objects (owners thereof).

On the other hand, it is also very useful for reducing power costs that large-scale power consumers with a large amount of power consumption such as factories, commercial facilities, railway stations, and airports can be supplied with electric power from individual transaction markets 3 without using power transmission lines of a system power network. In general, when electric power is supplied via a system power network (which includes a case in which electric power is supplied in a regular transaction market), a basic charge of a power charge is determined based on a maximum value of an amount of power demand in one year in the past. Accordingly, it is possible to curb a maximum value of an amount of electric power which a power consumer is supplied from the system power network in order to reduce power cost. However, an amount of power demand in a power consumer may increase transiently. In this case, particularly, in a time period (a peak time period) in which an amount of power consumption for each unit time period (normally 30 minutes) is greater than a predetermined value, a large-scale power consumer or the like takes a measure called “peak cut” of being supplied with an excess amount of electric power from the outside of the system power network to cause an amount of electric power received from the system power network to be equal to or less than a predetermined value. When a configuration in which the excess amount of electric power is supplied using an existing storage battery, an existing power generator, or the like is employed to perform the peak cut, high costs are required for introduction of facilities such as the storage battery or the power generator. On the other hand, when a configuration in which a contracted amount of electric power can be supplied from the individual transaction markets 3 at the time of peak cut is employed, it is not necessary to introduce facilities such as the storage battery or the power generator, which is advantageous in view of cost.

Here, when a contract for a transaction of electric power with a mobile object is tried using an individual transaction market 3 for the peak cut in a power consumer, it is important to consider the profit and loss and the costs associated with supply of electric power in the mobile object. When a merit exceeding the costs for electric power with which a mobile object is supplied from an individual transaction market 3 cannot be found, mobile objects do not gather actually in the individual transaction markets 3 in which the power consumer is tendering and thus there is a likelihood that an amount of electric power with which the power consumer can be supplied will be limited to the total amount of electric power stored in mobile objects with the sphere of jurisdiction of the power consumer. Accordingly, in order to enable a power consumer to be supplied with electric power from an individual transaction market 3, it is necessary to construct a system for enabling a mobile object (an owner thereof) to ascertain merits of a transaction of electric power in individual transaction markets.

Therefore, in this embodiment, a power transaction information providing system configured to provide information on transactions of electric power in which a power consumer makes a tender in an individual transaction market 3 to a mobile objects such that the mobile object can participate in a transaction of electric power with advantageous conditions in the P2P power transaction will be described.

Entire Configuration of Power Transaction Information Providing System

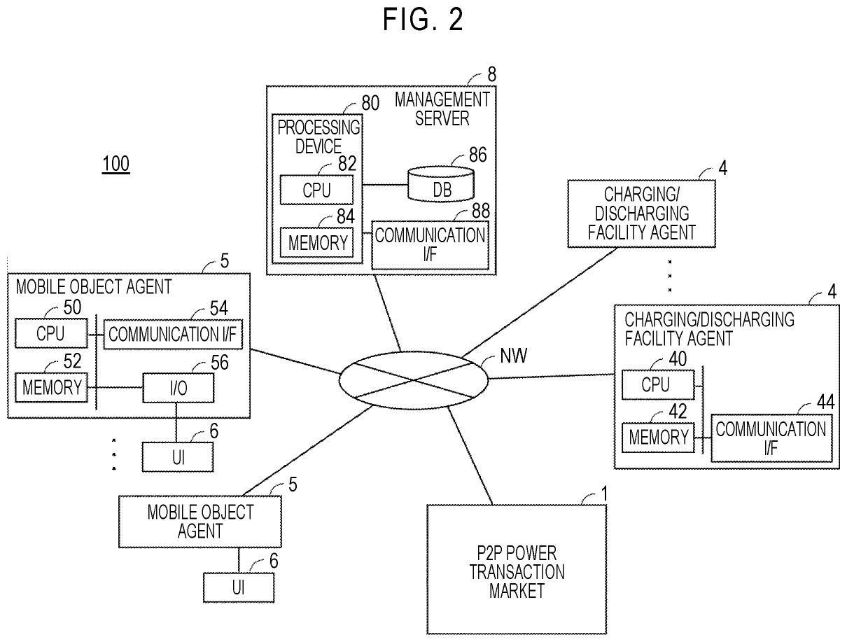

FIG. 2 is a diagram schematically illustrating the entire configuration of a power transaction information providing system according to this embodiment. As illustrated in FIG. 2, a power transaction information providing system 100 includes a management server 8, charging/discharging facility agents 4, and mobile object agents 5.

The management server 8 is a server that manages transactions of electric power in a P2P power transaction market. The management server 8 is configured to communicate with the charging/discharging facility agent 4, the mobile object agent 5, and the P2P power transaction market 1 via a communication network NW. The management server 8 corresponds to an example of a “power transaction management server.”

Specifically, the management server 8 includes a processing device 80, a database (DB) 86, and a communication interface (I/F) 88. The processing device 80 includes a processor 82 and a memory 84.

The processor 82 is, for example, a central processing unit (CPU) and is configured to perform a predetermined arithmetic process described in a program. This arithmetic process includes retrieval of an individual transaction market which will be described later.

The memory 84 includes a read only memory (ROM) and a random access memory (RAM). The ROM stores a program which is executed by the processor 82. The RAM temporarily stores data generated by executing a program in the processor 82 and data input via the communication I/F 88. The RAM also serves as a temporary data memory which is used as a work area.

The database 86 stores information on transactions of electric power (hereinafter also referred to as “power transaction information”) of the individual transaction markets 3 included in the P2P power transaction market 1. The power transaction information includes position information of a charging/discharging facility to or from which electric power is supplied or received and information on tender conditions which are provided to the individual transaction markets by power consumers. Details of the power transaction information will be described later.

The communication I/F 88 is configured to interactively communicate with external devices of the management server 8 (such as the charging/discharging facility agent 4, the mobile object agent 5, and the P2P power transaction market 1) via the communication network NW.

The charging/discharging facility agent 4 includes a processor 40, a memory 42, and a communication I/F 44. The processor 40 is, for example, a CPU and is configured to perform a predetermined arithmetic process described in a program. This arithmetic process includes a tender for a transaction of electric power in the P2P power transaction market 1.

The memory 42 includes a ROM and a RAM. The ROM stores a program which is executed by the processor 40. The RAM temporarily stores data generated by executing a program in the processor 40 and data input via the communication I/F 44. The RAM also serves as a temporary data memory which is used as a work area.

The communication I/F 44 is configured to interactively communicate with external devices of the charging/discharging facility agent 4 (such as the P2P power transaction market 1, the management server 8, and the mobile object agent 5) via the communication network NW.

The management server 8 may be configured integrally with an information processing device (a server) constituting the P2P power transaction market 1 or may be configured separately from the information processing device.

The charging/discharging facility agent 4 may be configured using a computer device provided in a power consumer or may be configured using cloud computing.

The mobile object agent 5 includes a processor 50, a memory 52, a communication I/F 54, and an input/output circuit (I/O) 56. The processor 50 is, for example, a CPU and is configured to perform a predetermined arithmetic process described in a program. This arithmetic process includes a tender for a transaction of electric power in the P2P power transaction market 1.

The memory 52 includes a ROM and a RAM. The ROM stores a program which is executed by the processor 50. The RAM temporarily stores data generated by executing a program in the processor 50 and data input via the communication I/F 54 and the I/O 56. The RAM also serves as a temporary data memory which is used as a work area.

The communication I/F 54 is configured to interactively communicate with external devices of the mobile object agent 5 (such as the P2P power transaction market 1, the management server 8, and the charging/discharging facility agent 4) via the communication network NW. The communication I/F 54 corresponds to an example of a “communication circuit.”

The input/output circuit 56 is connected to a user interface (UI) 6. The user interface 6 is, for example, a navigation device mounted in a mobile object or a mobile terminal (such as a tablet or a smartphone) that is operated by an owner of the mobile object. The processor 50 can output information to the user interface 6 via the input/output circuit 56 and receives a signal indicating an operation instruction given to the user interface 6. The input/output circuit 56 corresponds to an example of a “notification unit.”

The mobile object agent 5 may be configured using a computer device installed in the mobile object or may be configured using cloud computing.

Functional Configuration of Power Transaction Information Providing System

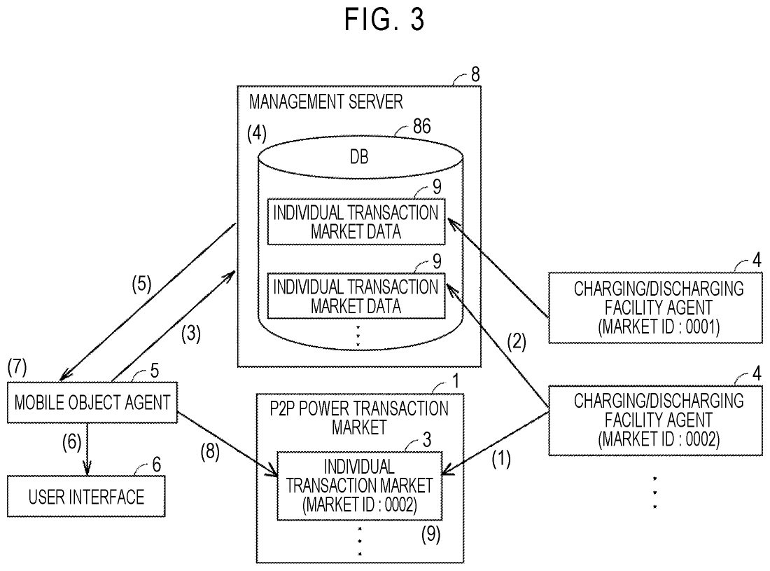

FIG. 3 is a diagram illustrating a routine of processes that are performed in the power transaction information providing system 100. Reference signs (1) to (9) in the drawing represent the order in which the processes are performed. The order of processes is not limited thereto.

As illustrated in FIG. 3, a power consumer makes a tender in an individual transaction market 3 formed in the P2P power transaction market 1 via a charging/discharging facility agent 4 (see (1) in the drawing). “Tender conditions for a transaction of electric power” provided by the charging/discharging facility agent 4 include a time period in which the corresponding charging/discharging facility can supply or receive electric power, an amount of electric power for each unit time period in the time period, and a market price for each unit time period for supply or reception of the amount of electric power.

The charging/discharging facility agent 4 transmits power transaction information including the tender conditions provided to the individual transaction market 3 to the management server 8 (see (2) in the drawing). The power transaction information includes position information of a charging/discharging facility that can supply or receive electric power in addition to the tender conditions.

When power transaction information is received from a charging/discharging facility agent 4, the management server 8 stores the received power transaction information in the database 86. As illustrated in FIG. 3, data associated with the power transaction information for each individual transaction market 3 is registered as “individual transaction market data” in the database 86. In this way, the power transaction information on a plurality of individual transaction markets 3 included in the P2P power transaction market 1 is stored in the database 86 of the management server 8.

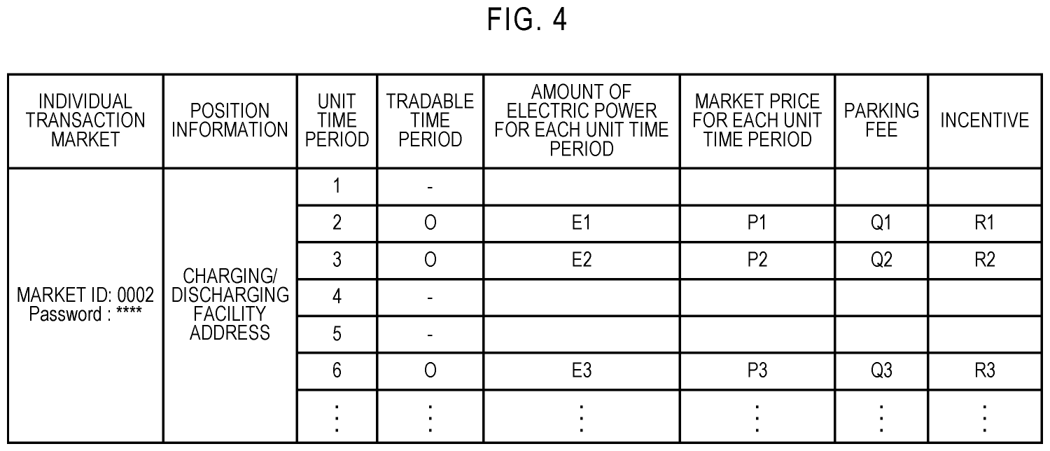

FIG. 4 is a diagram illustrating an example of a configuration of power transaction information. As illustrated in FIG. 4, the power transaction information includes a market ID and a password for each individual transaction market 3 and position information of a corresponding charging/discharging facility (such as an address of the charging/discharging facility).

The power transaction information further includes tender conditions in which a power consumer trades electric power in the corresponding individual transaction market 3. Specifically, the tender conditions include a “time period in which electric power is tradable (by a power consumer),” an “amount of electric power for each unit time period in the time period,” and a “market price for each unit time period.”

The “time period in which electric power is tradable” corresponds to a time period in which supply or reception of electric power to or from a charging/discharging facility is possible. In FIG. 4, whether electric power can be supplied or received is shown for each unit time period. Specifically, “0” indicates that electric power can be supplied or received by a charging/discharging facility, and “-” indicates that electric power cannot be supplied or received by a charging/discharging facility.

The “amount of electric power for each unit time period” is an amount of electric power which can be supplied or received by a charging/discharging facility for each unit time period. In a unit time period in which electric power can be supplied from a charging/discharging facility, a power consumer can make a tender for sale of electric power in an individual transaction market. On the other hand, in a unit time period in which electric power can be received by a charging/discharging facility, a power consumer can make a tender for purchase of electric power in an individual transaction market.

The “market price for each unit time period” is a price for selling or purchasing an amount of electric power for each unit time period.

The power transaction information further includes information on costs for a mobile object when the mobile object supplies or receives electric power to or from a charging/discharging facility. The costs for a mobile object include a parking fee when a mobile object parks at a power consumer.

The power transaction information further includes information on incentives. An incentive is given to a mobile object by a power consumer through a transaction of electric power and is representatively a monetary reward. The type of an incentive is not limited to a monetary reward, but may be appropriately set by each power consumer.

Referring back to FIG. 3, the mobile object agent 5 collects the power transaction information of an individual transaction market 3 which may be a tender destination using the management server 8 by communicating with the management server 8 to provide information of a mobile object to be managed thereto.

Specifically, first, the mobile object agent 5 transmits information of the mobile object to be managed to the management server 8 (see (3) in the drawing). The information of the mobile object includes information indicating a geographical range in which the mobile object can supply or receive electric power. The geographical range in which the mobile object can supply or receive electric power may include a current location of the mobile object or an area which is a living zone of an owner of the mobile object.

Alternatively, when a destination has been set in a navigation device mounted in the mobile object, the geographical range may include the destination and a travel route of the mobile object to the destination which has been set by allowing an owner of the mobile object to operate the navigation device. When the mobile object is a motor-driven vehicle configured to travel autonomously, the geographical range may include a travel route which has been prepared in advance.

The mobile object agent 5 may collect such information of the mobile object using an arithmetic operation device (for example, an electronic control unit (ECU)) provided in the mobile object. The mobile object agent 5 may be configured to collect travel data (trip information) of the mobile object from the past to the current time and to determine an area serving as a living zone based on the collected travel data.

The information of the mobile object may include information indicating a time period in which the mobile object can supply or receive electric power in addition to the information indicating the geographical range. The mobile object agent 5 is configured to collect information such as the travel data of the mobile object and data of a state of connection to a charging/discharging facility in a house or the like and to predict future states of use of the mobile object (such as travel data in the future, a place in which the mobile object is connected to a charging/discharging facility, and a stop time) based on the collected information. The mobile object agent 5 predicts a time period in which the mobile object can supply or receive electric power based on the predicted states of use of the mobile object and transmits the result of prediction to the management server 8.

When information of the mobile object is transmitted from the mobile object agent 5, the management server 8 sets retrieval conditions for retrieving an individual transaction market 3 which may serve as a tender destination of the mobile object based on the transmitted information (see (4) in the drawing).

The retrieval conditions may include geographical conditions. The geographical conditions can be set using information indicating a geographical range in which the mobile object can supply or receive electric power. Specifically, when the information indicating a geographical range in which the mobile object can supply or receive electric power is information indicating a current location of the mobile object, the management server 8 can set the geographical conditions such that a range in which a distance from the current location of the mobile object is equal to or less than a predetermined value is included.

Alternatively, when the information indicating a geographical range in which the mobile object can supply or receive electric power is information indicating a living zone of an owner of the mobile object, the management server 8 can set an area which is a living zone of the owner of the mobile object as the geographical conditions.

Alternatively, when the information indicating a geographical range in which the mobile object can supply or receive electric power is information indicating a travel route of the mobile object from the current location to a destination, the management server 8 can set the travel route and the destination as the geographical conditions.

The retrieval conditions may further include temporal conditions. The temporal conditions can be set using information indicating a time period in which the mobile object can supply or receive electric power. Specifically, the management server 8 can set the temporal conditions such that the time period in which the mobile object can supply or receive electric power is included.

Then, the management server 8 retrieves individual transaction market data matching the retrieval conditions out of a plurality of pieces of individual transaction market data registered in the database 86 using the set retrieval conditions (see (4) in the drawing). Through this retrieval, individual transaction market data in which position information of a charging/discharging facility matches the geographical conditions is extracted. When the retrieval conditions include geographical conditions and temporal conditions, individual transaction market data in which position information of a charging/discharging facility matches the geographical conditions and a time period in which the mobile object can trade electric power with the charging/discharging facility matches the temporal conditions are extracted by retrieval.

The extracted individual transaction market data corresponds to power transaction information in the individual transaction market 3 which may serve as a tender destination of the mobile object. The management server 8 provides the result of retrieval to the mobile object agent 5 (see (5) in the drawing). The result of retrieval includes power transaction information in the individual transaction market 3 which may serve as a tender destination of the mobile object as described above (see FIG. 4). Accordingly, in addition to the position information of the charging/discharging facility, information on the tender conditions in a transaction of electric power, the parking fee, and the incentive for the individual transaction market 3 which may serve as a tender destination of the mobile object is provided to the mobile object agent 5.

Accordingly, since power transaction information in an individual transaction market 3 is provided for charging/discharging facilities located with the geographical range in which a mobile object can supply or receive electric power, the mobile object agent 5 can efficiently collect power transaction information of individual transaction markets which may serve as a tender destination of the mobile object. Since the mobile object agent 5 can determine tender conditions in a transaction of electric power of the mobile object with reference to the provided power transaction information in at least one individual transaction market 3, the mobile object can participate in the transaction of electric power with advantageous conditions.

The mobile object agent 5 notifies an owner of the mobile object of the result of retrieval provided from the management server 8 via the user interface 6 (see (6) in the drawing). The user interface 6 is the navigation device mounted in the mobile object or a mobile terminal (such as a smartphone or a tablet) which is operated by the owner of the mobile object.

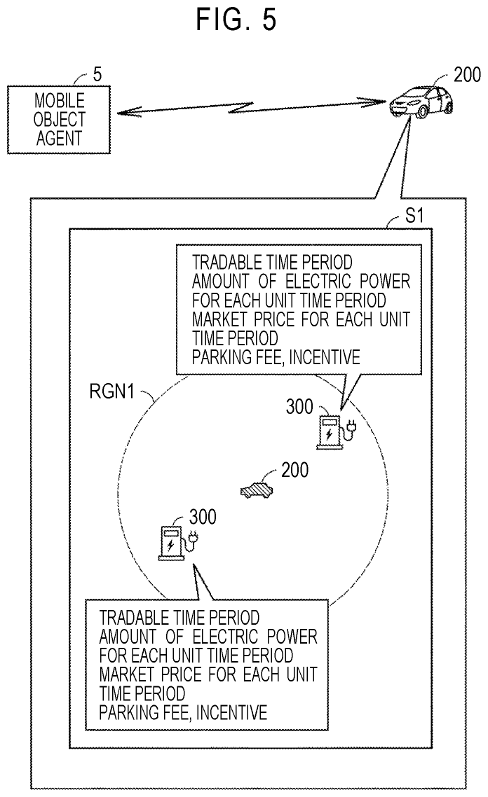

FIG. 5 is a diagram illustrating a first example of a result of retrieval which is displayed on the user interface 6. FIG. 5 schematically illustrates a screen which his displayed on a display of the navigation device mounted in a mobile object 200. A region RGN1 in the drawing indicates a range in which a distance from the current location of the mobile object 200 is equal to or less than a predetermined value which has been set in advance. On the screen, position information of charging/discharging facilities 300 located in the region RGN1 is displayed. In each charging/discharging facility 300, power transaction information in an individual transaction market corresponding to the charging/discharging facility 300 is additionally displayed.

With this configuration, an owner of the mobile object 200 can ascertain power transaction information in an individual transaction market 3 which may serve as a tender destination of the mobile object 200. When a plurality of individual transaction markets 3 serving as a tender destination is displayed as illustrated in FIG. 5, the owner of the mobile object 200 can compare the power transaction information between the plurality of individual transaction markets 3.

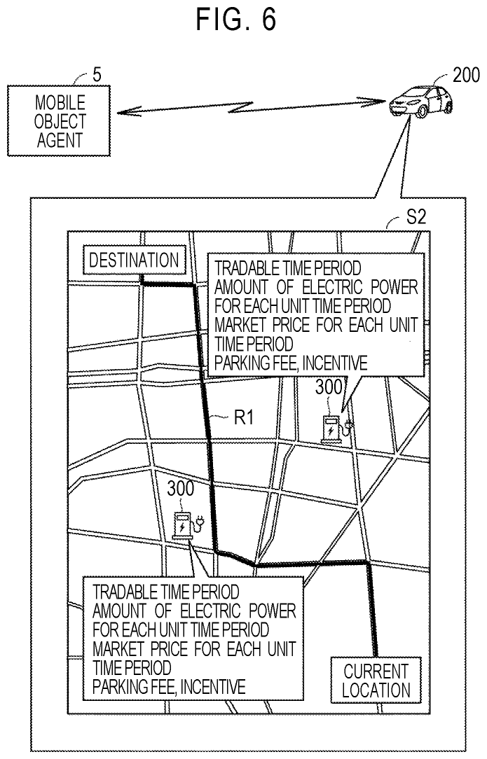

FIG. 6 is a diagram illustrating a second example of a retrieval result displayed on the user interface 6. Similarly to FIG. 5, FIG. 6 schematically illustrates a screen which is displayed on a display of the navigation device of a mobile object 200.

As illustrated in FIG. 6, a travel route R1 from a current location of a mobile object to a destination is displayed on the screen. The travel route R1 is retrieved by the navigation device in response to an input of a destination and is selected by an owner of the mobile object. When the mobile object 200 is configured to travel autonomously, a travel route which has been prepared in advance is displayed.

On the screen, position information of charging/discharging facilities 300 located near the travel route R1 is displayed. In each charging/discharging facility 300, power transaction information in an individual transaction market 3 corresponding to the charging/discharging facility 300 is additionally displayed. Although not illustrated, position information of charging/discharging facilities 300 located near the destination and power transaction markets in individual transaction markets corresponding to the charging/discharging facilities 300 can be additionally displayed on the user interface 6.

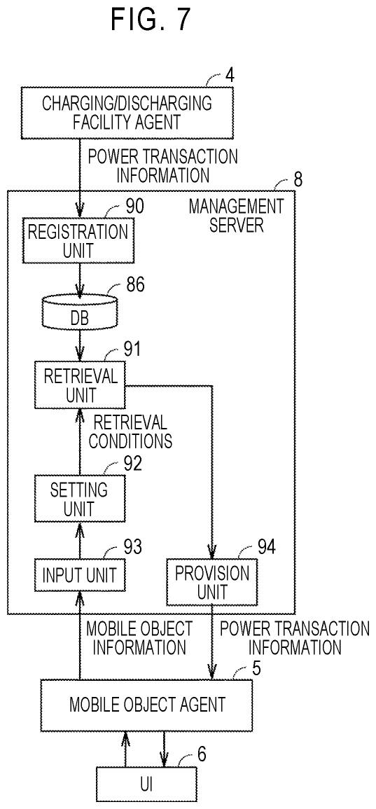

In the second example illustrated in FIG. 7, similarly to the first example illustrated in FIG. 6, an owner of the mobile object 200 can ascertain power transaction information in the charging/discharging facilities 300 located near the travel route R1 to the destination. When a plurality of charging/discharging facilities 300 is located near the travel route R1, the owner of the mobile object 200 can compare the power transaction information between the plurality of individual transaction markets 3.

Referring back to FIG. 3, the mobile object agent 5 retrieves an individual transaction market 3 serving as a tender destination of the mobile object and tender conditions in a transaction of electric power using the retrieval result provided from the management server 8 (see (7) in the drawing). Specifically, the mobile object agent 5 determines the individual transaction market 3 serving as a tender destination, an amount of electric power which is charged or discharged by the storage battery of the mobile object, and a market price for each unit time period as the tender conditions.

For example, when power transaction information in a plurality of individual transaction markets 3 corresponding to a plurality of charging/discharging facilities located in the range in which the distance from the current location of the mobile object is equal to or less than a predetermined value is provided as illustrated in FIG. 5, the mobile object agent 5 determines the tender conditions using the provided power transaction information in the plurality of individual transaction markets 3 such that the profit in a transaction of electric power in a range of an amount of electric power which can be charged or discharged by the storage battery of the mobile object is maximized with reference to the future state of use of the mobile object.

Alternatively, when power transaction information in a plurality of individual transaction markets corresponding to a plurality of charging/discharging facilities located near the travel route to the destination is provided as illustrated in FIG. 6 and it is predicted from the future state of use of the mobile object that the storage battery needs to be charged before the mobile object arrives at the destination, the mobile object agent 5 determines the tender conditions using the provided power transaction information in the plurality of individual transaction markets 3 such that the profit in a transaction of electric power in the range of an amount of electric power which can be charged or discharged by the storage battery of the mobile object is maximized without greatly changing the travel route to the destination and an arrival time at the destination.

When it is predicted that the storage battery need to be charged after the mobile object arrives at the destination, the mobile object agent 5 determines the tender conditions using the provided power transaction information in the plurality of individual transaction markets 3 such that the profit in a transaction of electric power in the range of an amount of electric power which can be charged or discharged by the storage battery of the mobile object is maximized without further moving the mobile object from the destination to the charging/discharging facilities located near the destination.

The mobile object agent 5 makes a tender in the individual transaction market 3 serving as a tender destination based on the determined tender conditions (see (8) in the drawing). Specifically, the mobile object agent 5 logs in to the individual transaction market 3 serving as a tender destination using the market ID and the password included in the power transaction information and makes a tender for sale or purchase for each unit time period based on the determined tender conditions. A contract for a transaction of electric power in which the tender conditions between the mobile object agent 5 and the charging/discharging facility agent 4 match is made (see (9) in the drawing).

Functional Configuration of Management Server and Mobile Object Agent

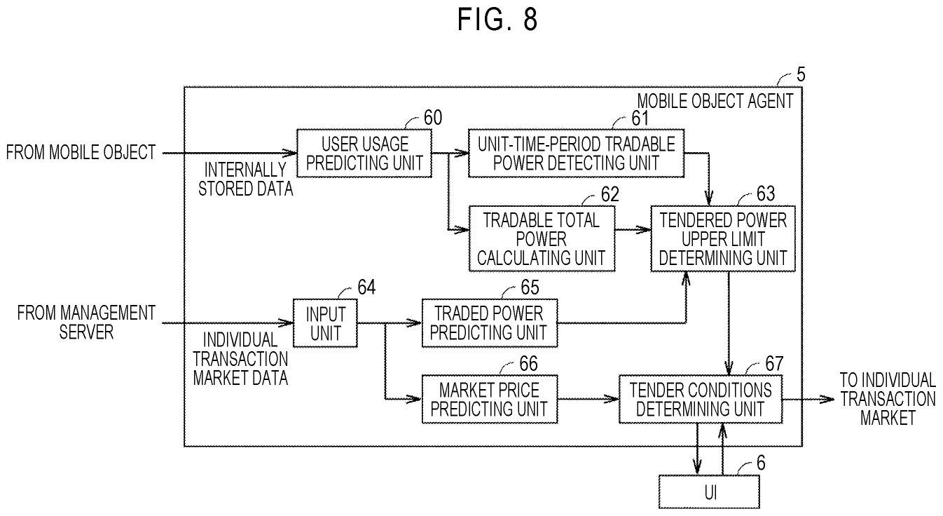

The functional configurations of the management server 8 and the mobile object agent 5 will be described below with reference to FIGS. 7 and 8.

FIG. 7 is a block diagram illustrating the functional configuration of the management server 8. As illustrated in FIG. 7, the management server 8 includes a registration unit 90, a database 86, a retrieval unit 91, a setting unit 92, an input unit 93, and a provision unit 94. These functional configurations are realized by causing the processor 82 in the management server 8 illustrated in FIG. 2 to execute a predetermined program.

The registration unit 90 receives power transaction information from each charging/discharging facility agent 4. As illustrated in FIG. 4, the power transaction information includes the tender conditions which are provided from each charging/discharging facility agent 4 to the corresponding individual transaction market 3, position information of a charging/discharging facility which electric power is supplied to or received from, and a market ID and a password of the individual transaction market 3. The registration unit 90 registers data indicating the received power transaction information of each individual transaction market 3 (individual transaction market data) in the database 86. The registration unit 90 registers the power transaction information for a plurality of individual transaction markets 3 included in the P2P power transaction market 1 in the database 86.

The input unit 93 receives information of a mobile object from the mobile object agent 5. The information of a mobile object includes at least information indicating a geographical range in which the mobile object can supply or receive electric power. The geographical range in which a mobile object can supply or receive electric power is, for example, a current location of the mobile object, a living zone of an owner of the mobile object, or a travel route of the mobile object from a current location to a destination.

The setting unit 92 sets retrieval conditions for retrieving an individual transaction market 3 serving as a tender destination of the mobile object based on the information of the mobile object. The retrieval conditions include geographical conditions which are set based on information indicating the geographical range in which the mobile object can supply or receive electric power.

The retrieval unit 91 retrieves individual transaction market data matching the retrieval conditions out of a plurality of pieces of individual transaction market data stored in the database 86 using the retrieval conditions set by the setting unit 92. In this retrieval, individual transaction market data in which the position information of a charging/discharging facility matches the geographical conditions included in the retrieval conditions is extracted.

The provision unit 94 provides the individual transaction market data extracted by the retrieval unit 91 to the mobile object agent 5. The provided individual transaction market data includes power transaction information in the individual transaction market 3 which may serve as a tender destination of the mobile object. Accordingly, position information of a charging/discharging facility, tender conditions in a transaction of electric power, and information on a parking fee and an incentive for the individual transaction market 3 serving as a tender destination are provided to the mobile object agent 5.

FIG. 8 is a block diagram illustrating the functional configuration of the mobile object agent 5. As illustrated in FIG. 8, the mobile object agent 5 includes a user usage predicting unit 60, a unit-time tradable power detecting unit 61, a tradable total power calculating unit 62, a tendered power upper limit determining unit 63, an input unit 64, a traded power predicting unit 65, a market price predicting unit 66, and a tender conditions determining unit 67.

The user usage predicting unit 60 collects data stored in the mobile object such as operation data (trip information) of the mobile object from the past to the current time, state of charge (SOC) change data of the storage battery, and a state of connection to a charging/discharging facility using an arithmetic processing device (for example, an ECU) provided in the mobile object, and predicts a future state of use of the mobile object based on the corrected data. The future state of use of the mobile object includes, for example, future travel data and a connection place and a stop time in a charging/discharging facility.

The unit-time tradable power detecting unit 61 detects an amount of electric power which can be charged or discharged by a storage battery of the mobile object for each unit time period when the mobile object is connected to a charging/discharging facility of an individual transaction market 3 serving as a tender destination using a prediction result from the user usage predicting unit 60. The amount of electric power which can be charged or discharged for each unit time period corresponds to an amount of electric power tradable for each unit time period. The charging/discharging facility which the mobile object supplies or receives electric power to or from is a charging/discharging facility corresponding to at least one individual transaction market 3 which may serve as a tender destination and which has been provided from the management server 8. The amount of electric power tradable for each unit time period may be detected by each charging/discharging facility of at least one individual transaction market 3.

The tradable total power calculating unit 62 calculates an amount of electric power which can be charged or discharged by the storage battery of the mobile object with reference to the SOC change data of the storage battery or the like. The amount of electric power which can be discharged by the storage battery corresponds to an amount of electric power from the current SOC of the storage battery to a lower limit of the SOC. The amount of electric power with which the storage battery can be charged corresponds to an amount of electric power from the current SOC of the storage battery to an upper limit of the SOC. Specifically, the tradable total power calculating unit 62 calculates an amount of electric power which can be charged or discharged by the storage battery by subtracting a predicted value of an amount of electric power consumed in traveling of the mobile object and estimated from future travel data from the current SOC of the storage battery detected from the SOC change data of the storage battery or a predicted value of a future SOC of the storage battery estimated from the SOC change data.

The tradable total power calculating unit 62 additionally calculates a total amount of electric power which can be supplied and received between a charging/discharging facility and the storage battery while the mobile object is stopped based on a predicted time in which the mobile object parks at the charging/discharging facility and a charging/discharging rate of the charging/discharging facility in the stop time.

The tradable total power calculating unit 62 finally calculates the smaller of the amount of electric power which can be charged or discharged by the storage battery and the amount of electric power which can be supplied or received between the charging/discharging facility and the storage battery as the total amount of tradable electric power.

The input unit 64 receives an input of data of at least one individual transaction market serving as a tender destination as a retrieval result from the management server 8.

The traded power predicting unit 65 predicts an amount of electric power which is traded by a power consumer from the current time to the future in each individual transaction market based on the data of at least one individual transaction market acquired from the input unit 64. The traded power predicting unit 65 predicts an amount of electric power traded by a power consumer for each unit time period in each individual transaction market based on the tender conditions of the power consumer included in the individual transaction market data.

The market price predicting unit 66 predicts a market price for each unit time period in each individual transaction market with reference to the data of at least one individual transaction market acquired from the input unit 64. The market price predicting unit 66 predicts the market price for each unit time period in each individual transaction market based on the tender conditions of a power consumer included in the individual transaction market data.

The tendered power upper limit determining unit 63 determines an upper limit of an amount of tendered electric power in the mobile object for each unit time period. The upper limit of the amount of tendered electric power in the mobile object for each unit time period corresponds to an upper limit of an amount of electric power which is charged or discharged in or from the storage battery of the mobile object and which is set for each unit time period. Accordingly, the amount of electric power for each unit time period in the tender conditions of the mobile object is determined to be equal to or less than the upper limited of the amount of tendered electric power. Specifically, when the amount of electric power tradable for each unit time and the total amount of tradable electric power are acquired, the tendered power upper limit determining unit 63 determines the upper limit of the amount of tendered electric power for each unit time period such that the amount of tendered electric power is distributed based on the amount of traded electric power of the power consumer for each unit time period.

When the upper limit of the amount of tendered electric power for each unit time period is determined, the tender conditions determining unit 67 determines the tender conditions such that the profit in the mobile object is maximized using the predicted value of the market price for each unit time period in each individual transaction market. The “profit is maximized” means that the loss is minimized when the loss caused in a transaction of electric power is greater than the profit.

The tender conditions determining unit 67 calculates the loss or profit caused in a transaction of electric power for each unit time period. The loss or profit includes costs and incentives which are generated in the transaction of electric power. Specifically, the loss or profit caused in a transaction of electric power includes a parking fee of the mobile object caused during the transaction and a monetary reward given to the transaction of electric power in addition to the loss or profit acquired by multiplying an amount of traded electric power by a market price.

The tender conditions determining unit 67 detects tender conditions in which the profit in the mobile object is maximized based on the calculated loss or profit. In detection of the tender conditions, an objective function of calculating costs caused in a transaction of electric power is set as an index indicating the loss or profit. Under constraint conditions for upper and lower limits of the SOC with which the storage battery of the mobile object is charged (a chargeable/dischargeable range of the storage battery), an amount of electric power to be sold or purchased for minimizing the objective function is detected. A process using an arbitrary numerical operation such as linear programming or convex optimization may be used as a process of optimizing the objective function.

When the process of optimizing the objective function is performed and optimal conditions are detected, an individual transaction market 3 serving as a tender destination is selected for each unit time period. The market price used in the optimal conditions and a desired amount of electric power to be purchased and a desired amount of electric power to be sold detected in the optimal conditions are determined as the tender conditions.

The tender conditions determining unit 67 makes a tender for a transaction of electric power in the individual transaction market 3 selected as a tender destination for each unit time period based on the determined tender conditions. When the tender in the individual transaction market 3 is made, the mobile object moves to a power consumer which is a transaction partner and performs supply or reception of electric power to or from a charging/discharging facility installed in the power consumer.

The tender conditions determining unit 67 may notify an owner of the mobile object of the determined tender conditions via the user interface 6 before the tender is made. In this configuration, when the notified tender conditions have been approved by the owner of the mobile object, the tender is made.

As described above, with the power transaction information providing system according to the first embodiment, the management server 8 is configured to retrieve power transaction information in an individual transaction market 3 which may serve as a tender destination of a mobile object based on information of the mobile object supplied from the mobile object agent 5 and to provide a result of retrieval to the mobile object agent 5. Accordingly, the mobile object agent 5 can determine tender conditions in a transaction of electric power of the mobile object such that the profit in the mobile object is maximized with reference to the power transaction information of at least one individual transaction market 3 serving as a tender destination. As a result, the mobile object can participate in a transaction of electric power with advantageous conditions.

### Second Embodiment

In the first embodiment, the configuration in which the management server 8 provides power transaction information of each individual transaction market which is provided from the charging/discharging facility agent 4 and which is stored in the database 86 in response to a request from the mobile object agent 5 has been described above.

However, in the aforementioned configuration, the tender conditions included in the power transaction information stored in the database 86 may not match the tender conditions of the charging/discharging facility agents 4 in the P2P power transaction market 1. For example, there may be a mismatch between a market price of electric power for each unit time period in a certain individual transaction market 3 and a market price of electric power for each unit time period included in power transaction information of the corresponding individual transaction market 3 stored in the database 86 of the management server 8. Such a mismatch of power transaction information may occur due to intention or negligence of a power consumer. The mismatch in power transaction information may cause a disadvantage in a mobile object that makes a tender in the individual transaction market 3.

Therefore, in a power transaction information providing system according to a second embodiment, a management server 8 is configured to determine whether power transaction information of individual transaction markets 3 stored in a database 86 matches power transaction information of individual transaction markets 3 in a P2P power transaction market 1. The entire configuration of the power transaction information providing system and the configurations of each charging/discharging facility agent 4 and each mobile object agent 5 are basically the same as in the first embodiment and thus description thereof will not be repeated.

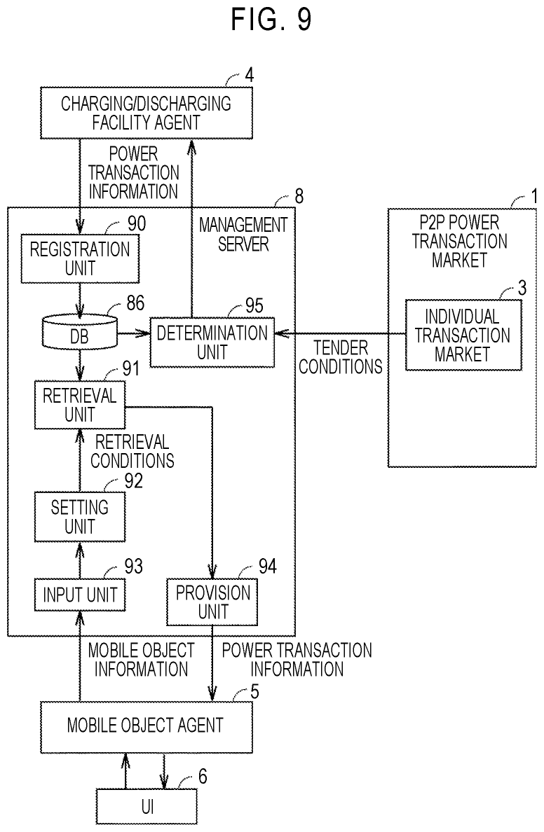

FIG. 9 is a block diagram illustrating the functional configuration of the management server 8 in the power transaction information providing system according to the second embodiment. The basic configuration of the management server 8 illustrated in FIG. 9 is the same as that of the management server 8 illustrated in FIG. 7 and is different therefrom in that a determination unit 95 is additionally provided. The functional configuration illustrated in FIG. 9 is realized by causing the processor 82 in the management server 8 illustrated in FIG. 2 to execute a predetermined program.

The determination unit 95 acquires tender conditions of a power consumer in a certain individual transaction market 3 by communicating with the individual transaction market 3 in the P2P power transaction market 1. The tender conditions include a time period in which the power consumer can trade electric power, an amount of electric power for each unit time period in the time period, and a market price for each unit time period.

The determination unit 95 reads data of power transaction information in the individual transaction market 3 (individual transaction market data) from the database 86. The determination unit 95 determines whether the tender conditions included in the read individual transaction market data matches the tender conditions in the individual transaction market 3 acquired from the P2P power transaction market 1 by comparing both tender conditions. When both tender conditions do not match (for example, when the market prices do not match), the determination unit 95 notifies the charging/discharging facility agent 4 of the determination result.

The notified charging/discharging facility agent 4 newly transmits power transaction information of the individual transaction market 3 in the P2P power transaction market 1 to the management server 8. In the management server 8, the registration unit 90 updates the individual transaction market data stored in the database 86 by overwriting the individual transaction market data stored in the database 86 with the newly transmitted tender conditions.

The determination process performed by the determination unit 95 may be periodically performed or may be performed when a request has been received from a mobile object agent 5.

With the management server 8 according to the second embodiment, it is possible to provide power transaction information based on the tender conditions in a transaction of electric power in an actual individual transaction market 3 to a mobile object agent 5. Accordingly, it is possible to prevent a disadvantage from being given to a mobile object that makes a tender in an individual transaction market 3 due to a mismatch in power transaction information.

### Third Embodiment

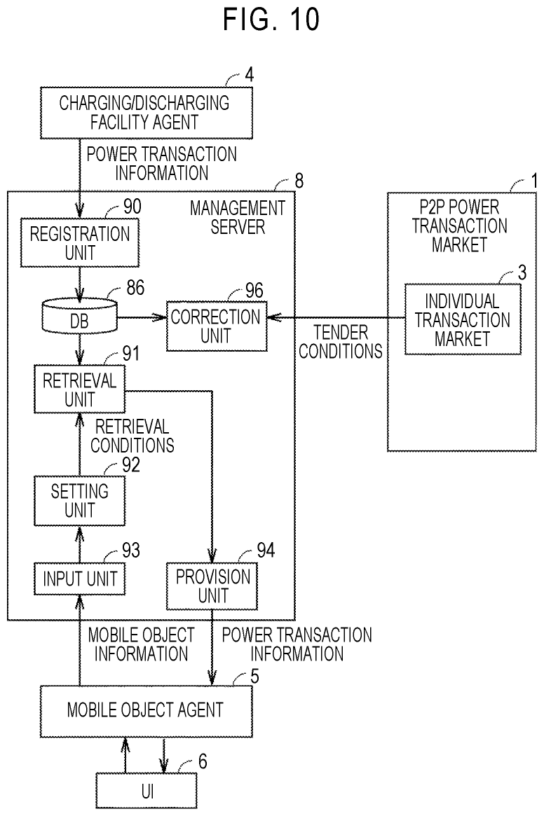

FIG. 10 is a block diagram illustrating the functional configuration of a management server 8 in a power transaction information providing system according to a third embodiment. The basic configuration of the management server 8 illustrated in FIG. 10 is the same as that of the management server 8 illustrated in FIG. 7 and is different therefrom in that a correction unit 96 is additionally provided. The functional configuration illustrated in FIG. 10 is realized by causing the processor 82 in the management server 8 illustrated in FIG. 2 to execute a predetermined program.

The correction unit 96 acquires tender conditions of a power consumer in a certain individual transaction market 3 by communicating with the individual transaction market 3 in the P2P power transaction market 1. The tender conditions include a time period in which the power consumer can trade electric power, an amount of electric power for each unit time period in the time period, and a market price for each unit time period.

The correction unit 96 reads data of power transaction information in the individual transaction market 3 (individual transaction market data) from the database 86. The correction unit 96 determines whether the tender conditions included in the read individual transaction market data matches the tender conditions in the individual transaction market 3 acquired from the P2P power transaction market 1 by comparing both tender conditions.

When both tender conditions do not match (for example, when the market prices do not match), the correction unit 96 corrects the individual transaction market data stored in the database 86 using the tender conditions acquired from the P2P power transaction market 1. The correction unit 96 corrects the tender conditions in the individual transaction market data stored in the database 86 to the tender conditions acquired from the P2P power transaction market 1.

With the management server 8 according to the third embodiment, similarly to the management server 8 according to the second embodiment, it is possible to provide power transaction information based on the tender conditions in a transaction of electric power in an actual individual transaction market 3 to a mobile object agent 5. Accordingly, it is possible to prevent a disadvantage from being given to a mobile object that makes a tender in an individual transaction market 3 due to a mismatch in power transaction information.

### Fourth Embodiment

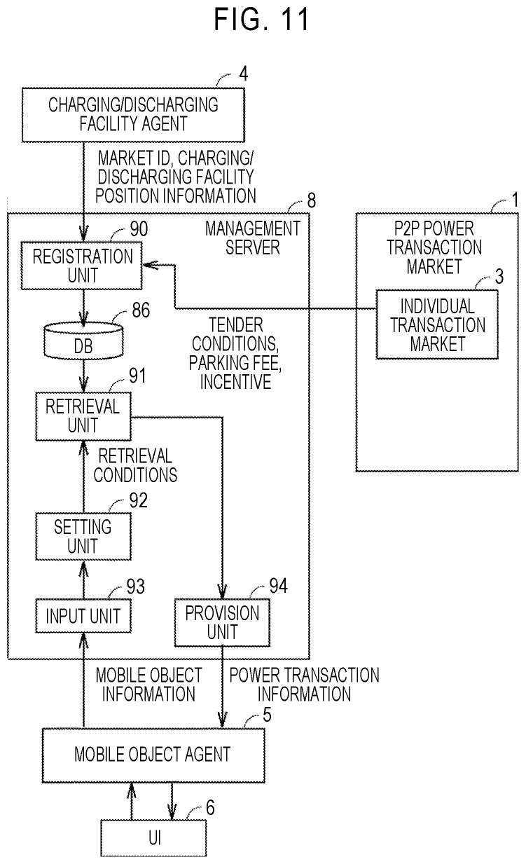

FIG. 11 is a block diagram illustrating the functional configuration of a management server 8 in a power transaction information providing system according to a fourth embodiment. The basic configuration of the management server 8 illustrated in FIG. 11 is the same as that of the management server 8 illustrated in FIG. 7 and is different therefrom in the configuration of the registration unit 90. The functional configuration illustrated in FIG. 11 is realized by causing the processor 82 in the management server 8 illustrated in FIG. 2 to execute a predetermined program.

As illustrated in FIG. 11, the registration unit 90 receives position information of a charging/discharging facility in which supply or reception of electric power is performed and a market ID and a password of an individual transaction market 3 from a charging/discharging facility agent 4. The registration unit 90 receives information on tender conditions which the charging/discharging facility agent 4 has provided to the individual transaction market 3 and a parking fee and an incentive from the individual transaction market 3 in the P2P power transaction market 1. The registration unit 90 registers such information received from the individual transaction market 3 as data indicating power transaction information (individual transaction market data) in the database 86 in correlation with the position information of the charging/discharging facility received from the charging/discharging facility agent 4. The registration unit 90 registers power transaction information of each of a plurality of individual transaction markets 3 included in the P2P power transaction market 1 in the database 86.

As described above, according to the fourth embodiment, the registration unit 90 is configured to acquire information on the tender conditions, the parking fees, and the incentives in the power transaction information by communicating with the individual transaction markets 3. In general, the P2P power transaction market 1 is constituted by a processing device (a server) having high tampering resistance of information. By employing a configuration in which information such as tender conditions important in a transaction of electric power is acquired from the P2P power transaction market 1, it is possible to improve reliability of power transaction information which is provided to a mobile object agent.

The aforementioned embodiment of the present disclosure is only exemplary but not restrictive in all respects. The scope of the present disclosure is defined by the appended claims, not by the aforementioned description of the embodiment, and is intended to include all modifications within the meanings and scope equivalent to the scope of the claims.

What is claimed is:

1. A power transaction management server that manages transactions of electric power in a power transaction market, the power transaction market including a plurality of individual transaction markets that is provided to correspond to a plurality of charging/discharging facilities, each of the plurality of individual transaction markets being configured to make a contract for a transaction of electric power directly supplied and received between the corresponding charging/discharging facility and a mobile object, the power transaction management server comprising:
a storage device;
a registration unit configured to receive power transaction information including positional information of the corresponding charging/discharging facility and tender conditions for a transaction of electric power and to register the received power transaction information in the storage device for each individual transaction market;
an input unit configured to receive information of the mobile object participating in the power transaction market, the information of the mobile object including information indicating a geographical range in which the mobile object is able to supply and receive electric power;
a setting unit configured to set retrieval conditions based on the information of the mobile object;
a retrieval unit configured to retrieve an individual transaction market matching the retrieval conditions out of the plurality of individual transaction markets; and
a provision unit configured to provide the power transaction information in the individual transaction market matching the retrieval conditions.

2. The power transaction management server according to claim 1, wherein the tender conditions includes a time period in which the corresponding charging/discharging facility is able to supply and receive electric power and a market price per unit time period in the time period.

3. The power transaction management server according to claim 2, wherein the tender conditions further include an amount of electric power per unit time period in the time period.

4. The power transaction management server according to claim 1, wherein the registration unit is configured to receive the power transaction information from a power transaction processing device for a charging/discharging facility and to register the received power transaction information in the storage device.

5. The power transaction management server according to claim 1, wherein the registration unit is configured to receive the positional information of the corresponding charging/discharging facility from the power transaction processing device for a charging/discharging facility, to receive the tender conditions from the individual transaction market, and to register the received tender conditions and the positional information of the corresponding charging/discharging facility in the storage device in correlation with each other.

6. The power transaction management server according to claim 1, wherein the information of the mobile object includes information indicating a current location of the mobile object, and
wherein the setting unit is configured to set a geographical range determined based on the current location of the mobile object as the retrieval conditions.

7. The power transaction management server according to claim 1, wherein the information of the mobile object includes information indicating an area that is a living zone of an owner of the mobile object, and
wherein the setting unit is configured to set a geographical range including the area corresponding to the living zone as the retrieval conditions.

8. The power transaction management server according to claim 1, wherein the information of the mobile object includes information indicating a travel route from a current location of the mobile object to a destination, and
wherein the setting unit is configured to set a geographical range determined to include the travel route as the retrieval conditions.

9. The power transaction management server according to claim 1, wherein the power transaction information further includes information on a parking fee of the mobile object that is caused when electric power is supplied and received between the corresponding charging/discharging facility and the mobile object.

10. The power transaction management server according to claim 1, wherein the power transaction information further includes information on an incentive that is applied to the mobile object with supply and reception of electric power between the corresponding charging/discharging facility and the mobile object.

11. The power transaction management server according to claim 2, further comprising a determination unit configured to acquire information on a market price per unit time period in the individual transaction market and to determine whether the acquired information on a market price per unit time period matches the information on a market price per unit time period stored in the storage device.

12. The power transaction management server according to claim 2, further comprising a correction unit configured to acquire information on a market price per unit time period in the individual transaction market and to correct the information on a market price per unit time period stored in the storage device to match the acquired information on a market price per unit time period.

13. A power transaction processing device for a mobile object, comprising a communication circuit configured to transmit the information on a mobile object participating in the power transaction market to the power transaction management server according to claim 1 and to receive the power transaction information in the individual transaction market matching the retrieval conditions from the power transaction management server.

14. The power transaction processing device for a mobile object according to claim 13, further comprising a notification unit configured to notify an owner of the mobile object of the power transaction information received by the communication circuit via a user interface.

15. The power transaction processing device for a mobile object according to claim 13, further comprising a determination unit configured to determine tender conditions for a transaction of electric power of the mobile object based on the power transaction information in the individual transaction market matching the retrieval conditions and a predicted state of use of the mobile object.

16. The power transaction processing device for a mobile object according to claim 15, wherein the determination unit is configured to calculate an amount of electric power according to which a storage battery of the mobile object is chargeable or dischargeable per unit time period and a total amount of electric power which the mobile object is able to supply or receive to or from the corresponding charging/discharging facility based on the predicted state of use of the mobile object and to determine a tendered power upper limit per unit time period in the mobile object based on the calculated amount of electric power according to which the storage battery of the mobile object is chargeable or dischargeable per unit time period, the calculated total amount of electric power which the mobile object is able to supply or receive to or from the corresponding charging/discharging facility, and an amount of electric power for each unit time period in the individual transaction market matching the retrieval conditions, and
wherein the determination unit is configured to determine the individual transaction market serving as a tender destination, an amount of electric power which the mobile object supplies or receives to or from the corresponding charging/discharging facility, and a market price for the electric power per unit time period based on the determined tendered power upper limit and the market price per unit time period in the individual transaction market matching the retrieval conditions.

17. The power transaction processing device for a mobile object according to claim 15, wherein the determination unit is configured to notify an owner of the mobile object of the determined tender conditions for the mobile object via a user interface and to make a contract when the tender conditions have been approved by the owner of the mobile object.
